(19) United States
(12) Patent Application Publication
(10) Pub. No.: US 2011/0295924 A1
(43) Pub. Date: Dec. 1, 2011

(54) METHODS, SYSTEMS, AND COMPUTER PROGRAM PRODUCTS FOR PREVENTING PROCESSING OF AN HTTP RESPONSE

(76) Inventor: Robert Paul Morris, Raleigh, NC (US)

(21) Appl. No.: 12/788,373

(22) Filed: May 27, 2010

(51) Int. Cl. G06F 15/16

(52) U.S. Cl. 709/202; 709/203

(57) ABSTRACT

Methods and systems are described for preventing processing of an HTTP response. In one aspect, first command information identifying a first command for sending in an HTTP request to a server is received from a user agent. A determination is made that no command response for the first command is to be received for delivery from the server to the user agent. A no-return indicator is set in a data storage media, in response to the determination. The first command is sent in the HTTP request to the server.

In another aspect, an HTTP request identifying a first command is received from a user agent. No-return-request information is detected for sending no command response for the command for delivery to the user agent. The command is processed, including sending no command response, to the command, for delivery to the user agent.

### RELATED APPLICATIONS

This application is related to the following commonly owned U.S. patent applications, the entire disclosure of each being incorporated by reference herein: application Ser. No. ______, (Docket No 0103) filed on May 27, 2010, entitled “Methods, Systems, and Program Products for Processing an Attached Command Response”; and

application Ser. No. ______, (Docket No 0150) filed on May 27, 2010, entitled “Methods, Systems, and Program Products for Processing a Combined Command Response”.

### BACKGROUND

The web is designed for requesting readily available resources. The protocol of the web, Hypertext Transfer Protocol (HTTP), is a request/response protocol. Hypertext Markup Language (HTML) supports this request/response model in commands identified in HTML markup elements. When a command identified in an HTTP request cannot be performed immediately a server can make a requesting user agent wait by holding a connection with the requester open until the command can be performed. Alternatively, the server may send an HTTP response including a status code indicating the command cannot be performed. Alternatively, some applications return a web page in the HTTP response that informs the user the s/he will be receive a response out-of-band via, for example, email. Other applications return a web page or other presentable representation that tells the user to check back later by sending another command via another HTTP request to check on the status of a long running command or an otherwise uncompleted command. Another option currently used, is to configure a server to return, to a browser, a script that repeatedly sends additional HTTP requests identifying a command until the command and/or related operation is complete. This occupies a window or tab of a web browser and requires the user to wait. If the user closes the waiting window or tab, the request is cancelled.

In some situations, it does not matter whether a user agent receives a response from a server. For example, if information provided in message to a server is merely informational, a user agent sending the information might have no need for a response. Given that HTTP is typically transmitted over reliable transport protocol, such as the Transmission Control Protocol (TCP), a user agent might require knowledge of transport failures. In another situation, data may be sent in real-time and/or otherwise change so rapidly that missing data in a message from time-to-time might not be critical to either or both the user agent sending the messages and the server receiving the messages. Neither HTTP nor HTML allow such situations to be processed efficiently and in some cases might not provide a workable solution.

Accordingly, there exists a need for methods, systems, and computer program products for preventing processing of an HTTP response.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for preventing processing of an HTTP response. In one aspect, the method includes receiving, from a user agent, first command information identifying a first command for sending in a first HTTP request to a server. The method further includes determining that the first command is non-returnable indicating that no command response for the first command is to be sent for delivery from the server to the user agent. The method still further includes setting, in response to the determination, a no-return indicator in a data storage media. The method additionally includes sending the first command information in the first HTTP request to the server, wherein the no-return indicator configures a node in a network path including the user agent and the server for sending no command response for the first command for delivery from the server to the user agent.

Further, a system for preventing processing of an HTTP response is described. The system includes an execution environment including an instruction-processing unit configured to process an instruction included in at least one of a request agent component, a no-response detector component, a no-response policy component, and a request-out component. The system includes the request agent component configured for receiving, from a user agent, first command information identifying a first command for sending in a first HTTP request to a server. The system further includes the no-response detector component configured for determining that the first command is non-returnable indicating that no command response for the first command is to be sent for delivery from the server to the user agent. The system still further includes the no-response policy component configured for setting, in response to the determination, a no-return indicator in a data storage media. The system still also includes the request-out component configured for sending the first command information in the first HTTP request to the server, wherein the no-return indicator configures a node in a network path including the user agent and the server for sending no command response for the first command for delivery from the server to the user agent.

In another aspect, a method for preventing processing of an HTTP response is described that includes receiving, from a user agent via a first HTTP request, first command information identifying a first command. The method further includes detecting no-return-request information identifying the first command as non-returnable for sending no command response for the first command from a server for delivery to the user agent. The method still further includes processing the first command including, in response to detecting the no-return-request information, sending no command response for the first command for delivery from the server to the user agent.

Still further, a system for preventing processing of an HTTP response is described. The system includes an execution environment including an instruction-processing unit configured to process an instruction included in at least one of a request-in component, a response detector component, and response director component. The system includes the request-in component configured for receiving, from a user agent via a first HTTP request, first command information identifying a first command. The system further includes the response detector component configured for detecting no-return-request information identifying the first command as non-returnable for sending no command response for the first command from a server for delivery to the user agent. The system still further includes the response director component configured for processing the first command including, in response to detecting the no-return-request information, sending no command response for the first command for delivery from the server to the user agent.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2a is a flow diagram illustrating a method for preventing processing of an HTTP response according to an aspect of the subject matter described herein;

FIG. 2b is a flow diagram illustrating a method for preventing processing of an HTTP response according to an aspect of the subject matter described herein;

FIG. 3a is a block diagram illustrating an arrangement of components for preventing processing of an HTTP response according to another aspect of the subject matter described herein;

FIG. 3b is a block diagram illustrating an arrangement of components for preventing processing of an HTTP response according to another aspect of the subject matter described herein;

FIG. 4 is a block diagram illustrating an arrangement of components for preventing processing of an HTTP response according to another aspect of the subject matter described herein;

FIG. 5 is a block diagram illustrating an arrangement of components for preventing processing of an HTTP response according to another aspect of the subject matter described herein;

FIG. 6 is a network diagram illustrating an exemplary system for preventing processing of an HTTP response according to an aspect of the subject matter described herein;

FIG. 7 is a diagram illustrating a user interface presented via a display according to an aspect of the subject matter described herein;

FIG. 8 is a message flow diagram illustrating a message flow in a system for preventing processing of an HTTP response according to an aspect of the subject matter described herein;

FIG. 9 Illustrates an exemplary request message according to an aspect of the subject matter described herein;

FIG. 10a Illustrates an exemplary request message according to an aspect of the subject matter described herein; and

FIG. 10b Illustrates an exemplary response message according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

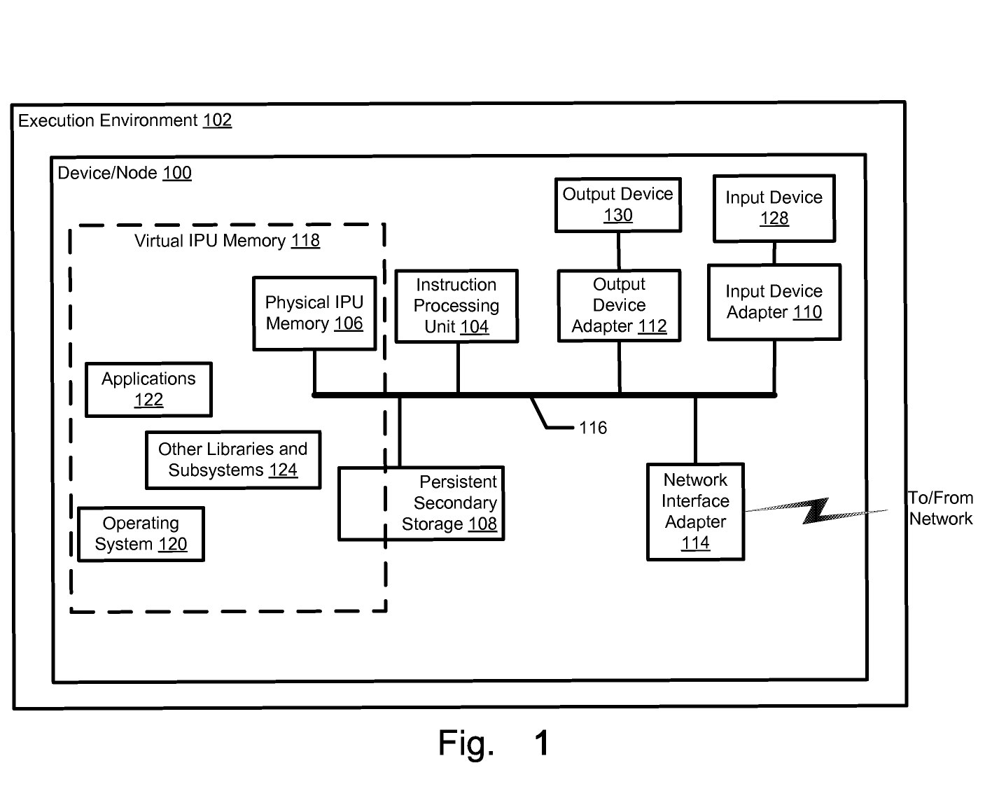

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, hand-held and other mobile devices, multiprocessor devices, distributed devices, consumer electronic devices, and/or other network-enabled devices. Those skilled in the art will understand that the components illustrated in FIG. 1 are exemplary and may vary by particular execution environment.

FIG. 1 illustrates hardware device 100 included in execution environment 102.

FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessed by IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a context referred to as a “process”. A process may include one or more “threads”. A thread includes a sequence of instructions executed by IPU 104 in a thread context. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network. The terms “device” and “node” as used herein refer to one or more devices and nodes, respectively, providing and/or otherwise included in an execution environment unless clearly indicated otherwise.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The Hypertext Transfer Protocol (HTTP) is specified in “Request for Comments” (RFC) document RFC 2616 by R. Fielding, et al., titled “Hypertext Transfer Protocol—HTTP/1.1” (June 1999). Terms from RFC 2616 are defined below as used herein and are used in describing the subject matter in this document.

An “HTTP request” as used herein is defined in section 5 of RFC 2616 along with adaptations and/or extensions described below. An “HTTP response” as used herein is defined in section 6 of RFC 2616 along with adaptations and/or extensions described below.

A “resource” is a data object or service that can be identified by a universal resource identifier (URI). An “HTTP entity” is information transferred as the payload of an HTTP request or an HTTP response. The term “HTTP entity” as used herein is defined as the term “entity” is defined in RFC 2616. An HTTP entity includes of meta-information in the form of entity-header fields and content in the form of an entity-body.

An “HTTP representation” is an HTTP entity that is subject to content negotiation. The term “HTTP representation” is used herein as the term “representation” is used and defined in RFC 2616.

The terms “user agent” and “server” refer to roles played by one or more components and/or devices operating in an execution environment, and/or systems in an HTTP communication. A “user agent” initiates and/or sends a command in an HTTP request. A “server” accepts a command identified in an HTTP request in order to process the command. The terms “server”, “service”, and “service provider” are used interchangeably herein. Processing a command includes performing and/or otherwise providing for performing the command. The performing of the command may be successful or unsuccessful. As defined and described herein a server may send information in an HTTP response to a user agent in response to receiving a command from the user agent in an HTTP request.

A command identified in an HTTP request may be processed by a service provider. For example, a service provider may retrieve and/or generate a resource in processing a command. As used herein, a “command response” is a result produced in processing a command, from a user agent, identified in an HTTP request. The command response is produced to return to the user agent. A command response is returned in an HTTP response as specified in RFC 2616 and as further described herein according to the subject matter.

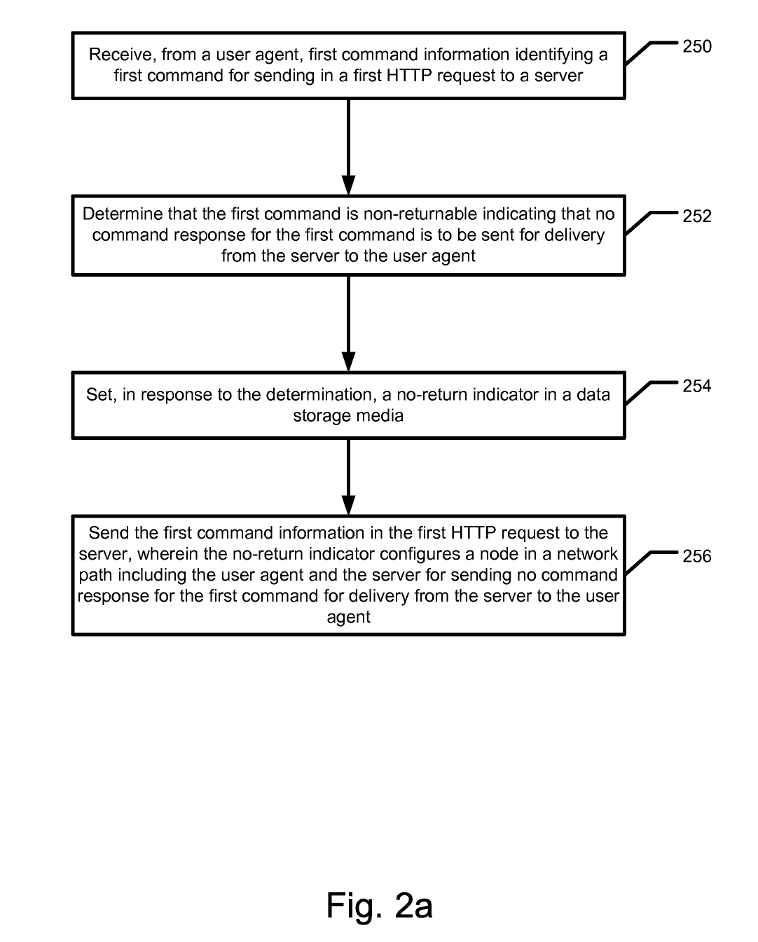

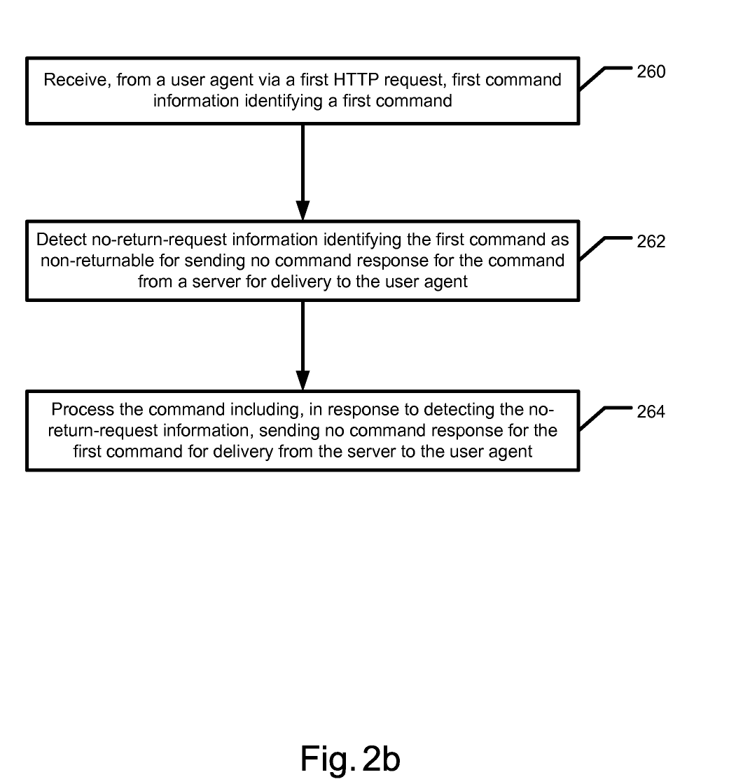

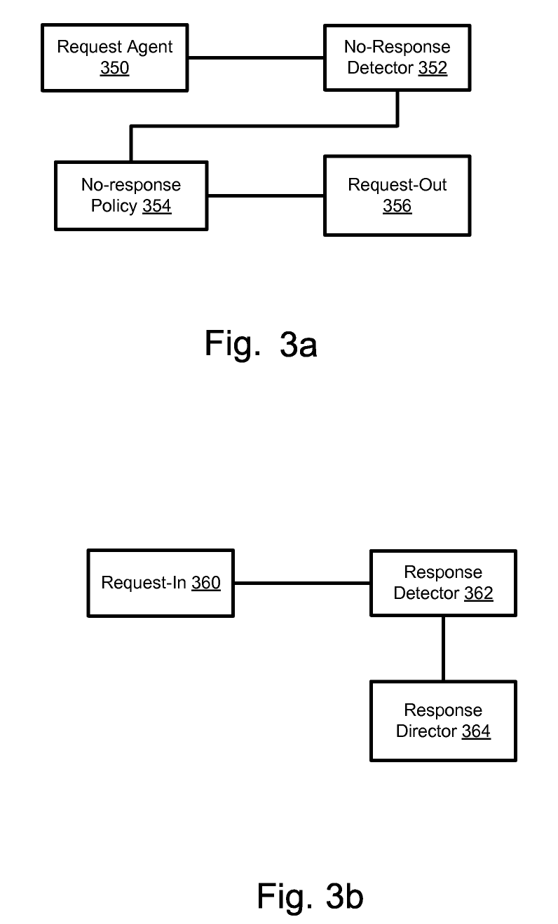

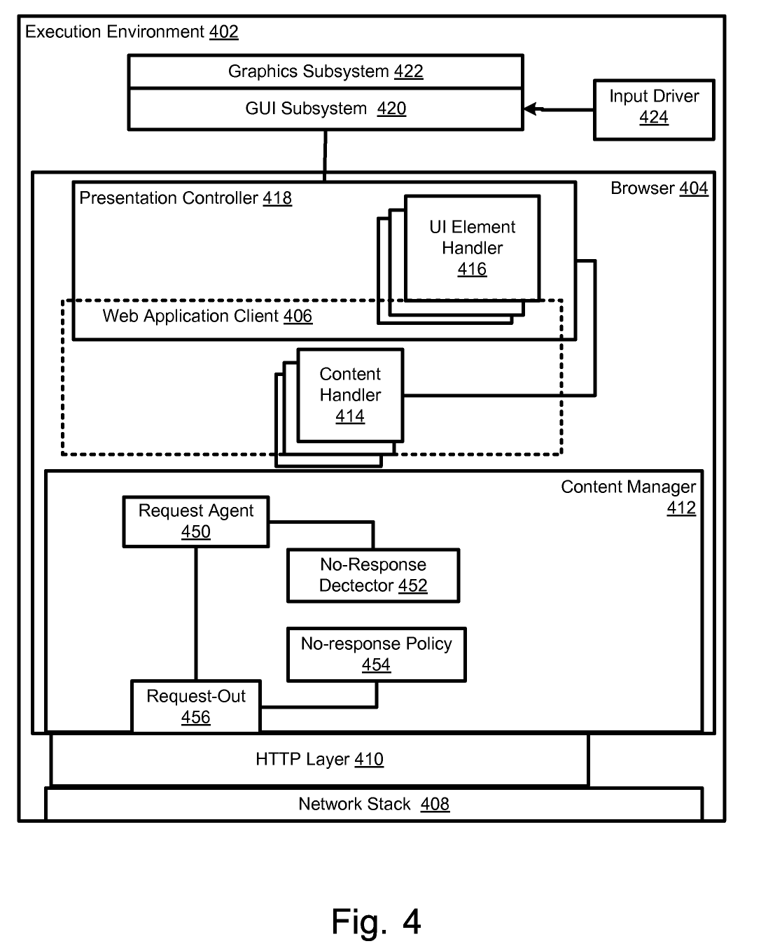

The block diagram in FIG. 3a illustrates an exemplary system for preventing processing of an HTTP response according to the method illustrated in FIG. 2a. A system for performing the method illustrated in FIG. 2a includes an execution environment, including an instruction-processing unit, configured to process an instruction included in at least one of a request agent component 350, a no-response detector component 352, a no-response policy component 354, and a request-out component 356 illustrated in FIG. 3a. Some or all of the exemplary components illustrated in FIG. 3a may be adapted for performing the method illustrated in FIG. 2a in a number of execution environments. FIG. 4 is a block diagram illustrating the components of FIG. 3a and/or analogs of the components of FIG. 3a adapted for operation in execution environment 402 including or otherwise provided by one or more nodes.

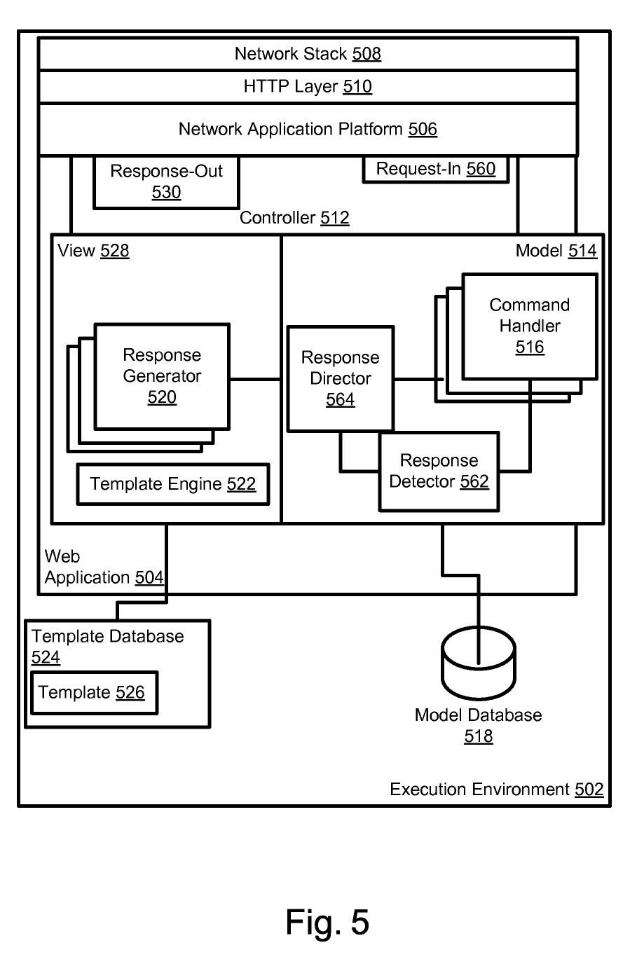

The block diagram in FIG. 3b illustrates an exemplary system for preventing processing of an HTTP response according the method illustrated in FIG. 2b. A system for performing the method illustrated in FIG. 2b includes an execution environment, including an instruction-processing unit, configured to process an instruction in at least one of a request-in component 360, a response detector component 362, and a response director component 364 illustrated in FIG. 3b. Some or all of the exemplary components illustrated in FIG. 3b may be adapted for performing the method illustrated in FIG. 2b in a number of execution environments. FIG. 5 is a block diagram illustrating the components of FIG. 3b and/or analogs of the components of FIG. 3b adapted for operation in execution environment 502 including or otherwise provided by one or more nodes.

FIG. 1 illustrates components of an exemplary device that may at least partially provide and/or otherwise be included in an execution environment. The components illustrated in FIG. 4 and FIG. 5 may be included in or otherwise combined with the components of FIG. 1 to create a variety of arrangements of components according to the subject matter described herein.

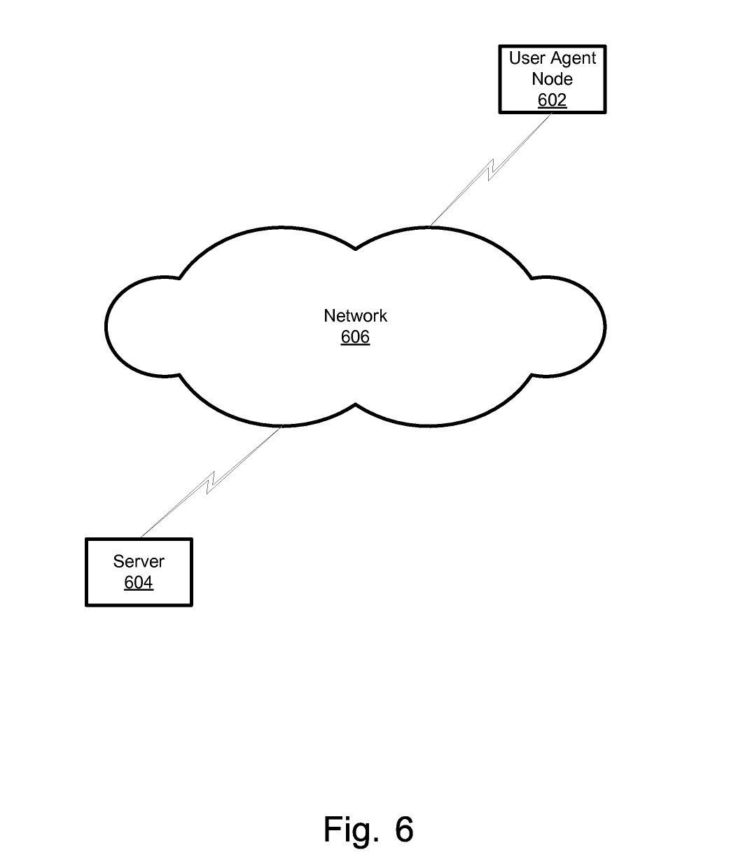

FIG. 6 illustrates user agent node 602 and server node 604 as exemplary devices included in and/or otherwise adapted for providing execution environment 402 and execution environment 502, respectively. As illustrated in FIG. 6, user agent node 602 and server node 604 are operatively coupled to network 606 via respective network interface components enabling user agent node 602 and server node 604 to communicate.

FIG. 4 illustrates execution environment 402 hosting a web browsing application illustrated as browser 404. It is common in HTTP communications for a browser and/or a web application agent operating in a browser to operate as user agents. FIG. 4 illustrates browser 404 including an adaptation of the arrangement of components in FIG. 3a. Web application agent 406 is illustrated operating in browser 404 and may be received from a remote application provider, such as web application 504 in FIG. 5. Browser 404 and execution environment 402 may provide at least part of an execution environment for web application agent 406. Browser 404, web application agent 406, HTTP layer 410, and/or user agent node 602 may operate in the role of user agent and/or may include a component operating as a user agent. FIG. 5 illustrates execution environment 502 hosting web application 504, typically operating in the role of a server in an HTTP communication. FIG. 5 illustrates an adaptation of the arrangement of components in FIG. 3b operating in web application 504.

As stated, the various adaptations of the arrangements in FIG. 3a and in FIG. 3b are not exhaustive. For example, those skilled in the art will see based on the description herein that arrangements of components for performing the methods illustrated in FIG. 2a and FIG. 2b may be distributed across more than one node and/or execution environment. For example, such an arrangement may operate at least partially in browser 404 in FIG. 4 and at least partially in execution environment 502 in FIG. 5.

FIG. 4 illustrates network stack 408 configured for sending and receiving messages over network 606 in FIG. 6, such as the Internet, via a network interface component of user agent node 602. FIG. 5 illustrates a network application platform 506 providing services to one or more web applications. FIG. 5 also illustrates network application platform 506 configured for interoperating with network stack 508. Network stack 408 and network stack 508 may support the same protocol suite, such as TCP/IP, or may communicate via a network gateway or other protocol translation device and/or service. Browser 404 in FIG. 4 and network application platform 506 in FIG. 5 may interoperate via their respective network stacks. Browser 404 and web application 504 may communicate via one or more application layer protocols. FIG. 4 illustrates HTTP layer 410 exemplifying an application layer protocol. FIG. 5 illustrates a compatible HTTP protocol layer as HTTP layer 510.

Browser 404, in FIG. 4, may receive some or all of web application agent 406 in one more messages sent from web application 504, in FIG. 5, via network application platform 506; and network stacks, network interface components, and optionally HTTP layers in the respective execution environments. In FIG. 4, browser 404 includes content manager component 412. Content manager component 412 may interoperate with HTTP layer component 410 and/or network stack 408 to receive the message or messages including some or all of web application agent 406.

Web application agent 406 may include a web page or other data representation for presenting a user interface for web application 504. The web page may include and/or reference data represented in one or more formats including hypertext markup language (HTML) and/or other markup languages, ECMAScript or other scripting languages, byte code, image data, audio data, and/or machine code to name just a few valid data representations depending on the capabilities of a receiving user agent node.

In response to an HTTP request including a command received from browser 404, controller component 512, in FIG. 5, may invoke model subsystem 514 to perform command specific processing. Model subsystem 514 may include any number of command processors, illustrated as command handler components 516, for dynamically generating data and/or retrieving data from model database 518 based on the command. Controller component 512 may further invoke one or more response generator components 520 for generating a command response to the received command. The one or more response generator components 520 may invoke template engine component 522 to identify one or more templates and/or other static data to combine with data received from command handler component(s) 516 generated in processing the command. FIG. 5 illustrates template database 524 including an exemplary template 526. The one or more response generator component(s) 520 in view subsystem 528 may interoperate with response-out component 530 in controller component 512 to return a command response generated from processing a command. The command response may be returned in one or more data formats suitable for a user agent, such as browser 404. Response-out component 530 may receive command response data from one or more response generator components 520 as one or more HTTP entities, and/or one or more HTTP representations. Alternatively or additionally, response-out component 530 may transform data from one or more response generator component(s) 520 into one or more HTTP entities and/or HTTP representations. Response-out component 530 may send the one or more HTTP entities in an HTTP response, in response to the HTTP request received from browser 404. Some or all of web application agent 406 may be sent to browser 404 via network application platform 506 in the manner described.

One or more HTTP responses including one or more representations of some or all of web application agent 406 may be received by content manager component 412 via HTTP layer 410 and network stack 408. In FIG. 4, browser 404 includes one or more content handler components 414 to process received HTTP representations according to their data types, typically identified by MIME-type identifiers. Exemplary content handler components 414 include a text/html content handler component for processing HTML representations; an application/xmpp-xml content handler component for processing XMPP streams including presence tuples, instant messages, and publish-subscribe data as defined by various XMPP specifications; one or more video content handler components for processing video representations of various types; and still image data content handler components for processing various image data representations. Content handler component(s) 414 process received HTTP representations and may provide data from the HTTP representations to one or more user interface element handler components 416.

User interface element handler components 416 are illustrated in presentation controller component 418 in FIG. 4. Presentation controller component 418 may manage visual, audio, and other types of output for its including application as well as receive and route detected user and other inputs to components and extensions of its including application, browser 404. With respect to FIG. 4, a user interface element handler component 416 may be adapted to operate at least partially in a content handler component 414 such as a text/html content handler component and/or a script content handler component. Additionally or alternatively, a user interface element handler component in execution environment 402 may operate in web application agent 406 and/or other extension of its including application, such as a plug-in providing a virtual machine for script and/or byte code.

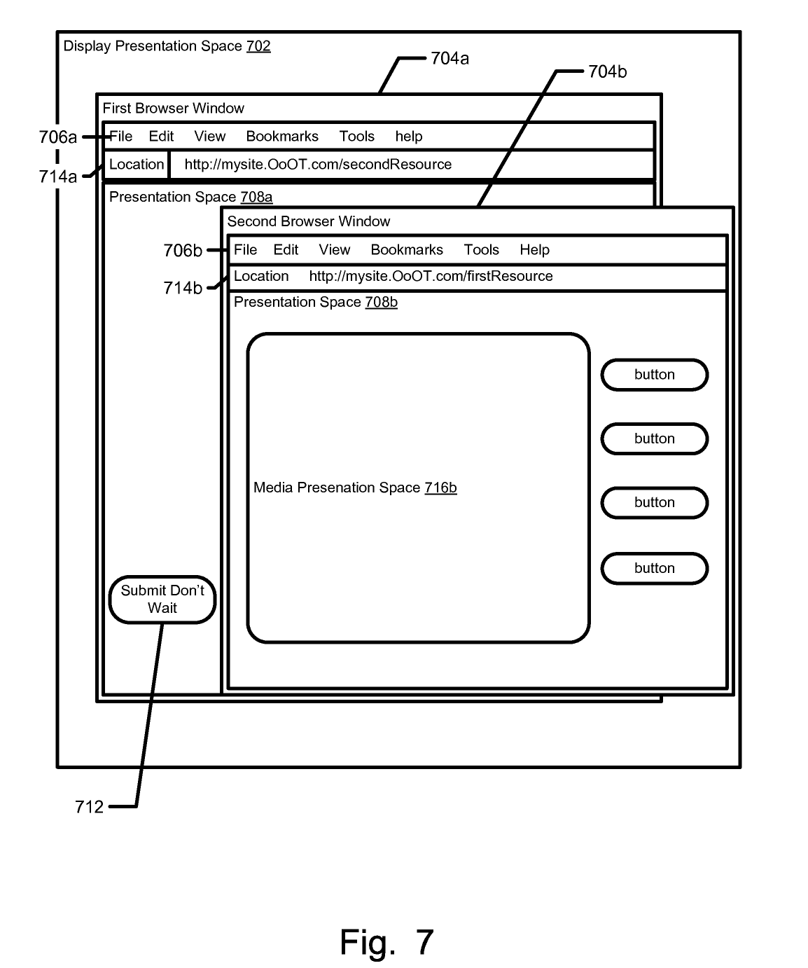

FIG. 7 illustrates a presentation space 702 of a display device, such as output device 130 in FIG. 1. Presentation space 702 includes first browser window 704a of browser 404, web application agent 406, and/or web application 504. FIG. 7 is used to illustrate various exemplary visual components of one or more of browser 404, web application agent 406, and web application 504.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual component”, and “visual interface element” are used interchangeably in this document. Other types of user interface elements include audio output components referred to as audio interface elements, tactile output components referred to as tactile interface elements, and the like.

A “user interface (UI) element handler” component, as the term is used in this document, includes a component configured to send information representing a program entity for presenting a user detectable representation of the program entity by an output device, such as a display. A “program entity” is an object included in and/or otherwise processed by an application or executable program component. The user detectable representation is presented based on the sent information. The sent information is referred to herein as “presentation information”. Presentation information may include data in one or more formats. Exemplary formats include image formats such as JPEG, video formats such as MP4, markup language data such as HTML and other XML-based markup, and/or instructions such as those defined by various script languages, byte code, and/or machine code. For example, a web page received by a browser from a remote application provider may include HTML ECMAScript, and/or byte code for presenting one or more user interface elements included in a user interface of the remote application. Components configured to send information representing one or more program entities for presenting particular types of output by particular types of output devices include visual interface elements, audio interface element handler components, tactile interface element handler components, and the like.

A representation of a program entity may be represented and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory, secondary storage, a memory of an output device adapter device, and/or a storage medium of an output device. A screen of a display, for example, is a presentation space.

As used herein, the term “program” or “executable” refers to any data representation that may be translated into a set of machine code instructions and optionally associated program data. Thus, a program or executable may include an application, a shared or non-shared library, and a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program specifiable in a source code language, which is addressable within a compatible execution environment. Examples of addressable entities include variables, constants, functions, subroutines, methods, classes, anonymous scoped instruction sets, and labeled instructions. Strictly speaking, the addressable entity contains a value or an instruction, but it is not the value or the instruction. In some places, this document will use “addressable entity” in a manner that refers to the content or value of an addressable entity. In these cases, the context will clearly indicate the intended meaning.

Addressable entities may have a number of corresponding representations. These representations include source code, object code, and any intermediate formats used by an interpreter, compiler, linker, loader, or analogous tool. Thus, terms such as “addressable source code entity” may be used in cases where the format is relevant and may be unclear from the context.

Returning to FIG. 7, first browser window 704a and second browser window 704b collectively and generically are referred to as browser window(s) 704. Browser windows 704 illustrate a number of visual user interface elements commonly found in applications. Browser windows 704 include respective menu bars 706 with menu controls for receiving user input to identify commands to perform. Browser windows 704 also include respective user interface elements providing respective presentation spaces 708 for presenting content including other visual components.

Various user interface elements of browser 404, web application agent 406, and/or web application 504 described above may be presented by one or more user interface element handler components 416 and/or response generator components 520. User interface element handler component(s) 416 in FIG. 4 may send presentation information representing a visual interface element(s), such as menu bar 706 illustrated in FIG. 7, to GUI subsystem 420. GUI subsystem 420 may instruct graphics subsystem 422 to draw the visual interface element(s) in a region of display presentation space 702 in FIG. 7, based on the presentation information.

Input may be received via input driver 424 in FIG. 4. For example, a user may move a mouse to move a pointer presented in display presentation space 702 over an operation identifier in menu bar 706. The user may provide an input detected by the mouse. The detected input may be received by GUI subsystem 420 via input driver 424 as an operation or command indicator based on the association of the shared location of the pointer and the operation identifier in display presentation space 702.

With reference to FIG. 2a, block 250 illustrates that the method includes receiving, from a user agent, first command information identifying a first command for sending in a first HTTP request to a server. Accordingly, a system for preventing processing of an HTTP response includes means for receiving, from a user agent, first command information identifying a first command for sending in a first HTTP request to a server. For example, as illustrated in FIG. 3a, request agent component 350 is configured for receiving, from a user agent, first command information identifying a first command for sending in a first HTTP request to a server. FIG. 4 illustrates request agent component 450 as an adaptation of and/or analog of request agent component 350 in FIG. 3a. One or more request agent components 450 operate in execution environment 402.

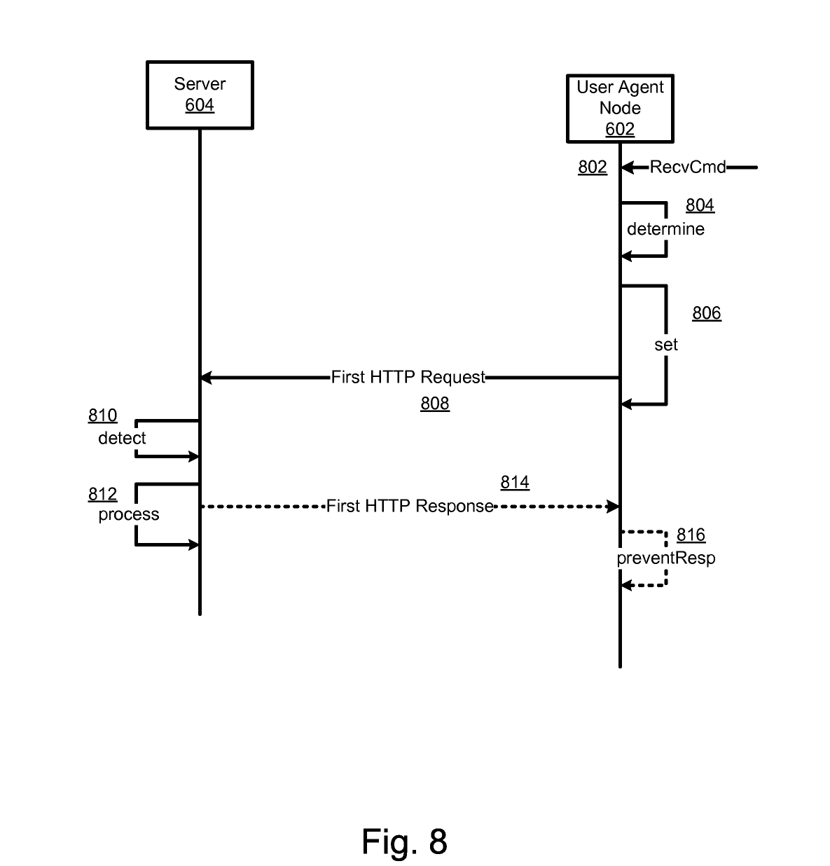

FIG. 8 is a message flow diagram illustrating an exemplary exchange of messages between and within user agent node 602 and server node 604 according to the subject matter described herein. FIG. 8 illustrates recvCmd message 802 communicated within user agent node 602 and/or otherwise communicated to user agent node 602 recvCmd message 802 communicates command information identifying a command to send by user node 602 in an HTTP request to server node 604.

The user agent for recvCmd message 802 may be a web application agent operating in a browser and/or the browser. A user agent may include and/or may process a web page including markup such as HTML including command information for sending a request to a server. Alternatively or additionally, a user agent may include and/or may process script instructions and/or other executable code received from a server node. RecvCmd message 802 in FIG. 8 may be communicated from web application agent 406 to browser 404 in FIG. 4. A user agent may include a component of a browser. For example, recvCmd message 802 may be communicated between a content handler component 414 and request-out component 456. A user agent may include a browser. In another example, recvCmd message 802 may be communicated between a request-out component 456 and HTTP layer 410. In FIG. 4, recvCmd message 802 may be communication from browser 404 to HTTP layer 410. The examples provided in this paragraph are not mutually exclusive. An adaptation of the arrangement of components illustrated in FIG. 3a may be included at various points in the path of a requested command sent to a server. Those skilled in the art will appreciate that with respect to the subject matter described herein various nodes and/or components included in sending command information in an HTTP request to a server node may be user agents and may send recvCmd message 802 and/or an analog of recvCmd message 802.

A user agent and/or a server may included and/or may be included in web application agent, a component of a browser, a browser, a web server, a web application platform, a web application, a gateway node, and/or a proxy node.

Command information such as communicated in recvCmd message 802 may be received in a variety of computing contexts according to various aspects. Command information may be received, for example, in response to a detected user input, in response to execution of an instruction received in an HTTP message, in response to processing of a markup-element received in an HTTP message, and/or command information may be received in an HTTP request and/or in a portion of an HTTP request. When received in an HTTP request or a portion thereof, command information may identify a command based on an HTTP method token, at URI, an HTTP request line, an HTTP general header, an HTTP request header, an HTTP entity, and/or an HTTP representation.

Command information may be received and/or otherwise identified in response to a user input detected by an input device. The user input may correspond to a UI element presented via an output device. Input information based on the detected user input may be received by presentation controller component 418 in FIG. 4 and/or a UI element handler component 416 corresponding to a hyperlink in a web page in web application agent 406. The link may correspond to button UI element 712 in FIG. 7, which may or may not be defined by markup information specifying button 712 in a form. A detected user input may correspond to an item in a bookmarks menu as illustrated in menu bars 706, a history list (not shown), and/or a navigation control UI element. A URI may be received by presentation controller component 418 and/or a UI element handler component 416 via a keypad (physical or virtual) providing input for a location bar 714. A web page may include a reference to, for example, a media representation for presenting in media presentation space 716b in the web page presented in presentation space 708b. A content handler component 414 processing the web page may detect a URI included in the reference. A resource such as the media representation may be retrieved by a script content handler component 414 interpreting a script included in web application agent 406, a media player plug-in, and/or other browser 404 extension in and/or otherwise interoperating with web application agent 406.

In the examples in the previous paragraphs, various user inputs, instructions, and references identify a URI. A URI may identify a command for performing by a server or may be included in command information in an HTTP request that identifies a command. In some aspects, command information may include information in one or more headers and/or HTTP entities. For example, a session identifier or information associated with a cookie may be combined with some or all of a URI to identify a command. Message body data may be included in command information identifying a command in some HTTP requests.

An indication to send first HTTP request 808 in FIG. 8 may be received by content manager component 412 from any of a various user interface element handler components 416 and/or other components operating in and interoperating with browser 404, such as web application agent 406. Content manager component 412 may format data identifying the command for including in first HTTP request 808. Content manager component 412 may provide the formatted data including command information to request-out component 456 to send first HTTP request 808 to server node 604 identified in first HTTP request 808.

Returning to FIG. 2a, block 252 illustrates that the method yet further includes determining that the first command is non-returnable indicating that no command response for the first command is to be sent for delivery from the server to the user agent. Accordingly, a system for preventing processing of an HTTP response includes means for determining that the first command is non-returnable indicating that no command response for the first command is to be sent for delivery from the server to the user agent. For example, as illustrated in FIG. 3a, no-response detector component 352 is configured for determining that the first command is non-returnable indicating that no command response for the first command is to be sent for delivery from the server to the user agent. FIG. 4 illustrates no-response detector component 452 as an adaptation of and/or analog of no-response detector component 352 in FIG. 3a. One or more no-response detector components 452 operate in execution environment 402

In FIG. 8, determine message 804 is communicated in user agent node 602 to determine and/or otherwise detect that the command identified in recvCmd message 802 is a non-returnable command.

FIG. 4 illustrates no-response detector component 452 operating in content manager component 412. No-response detector 452 may receive and/or otherwise determine that the command identified in recvCmd message 802 is non-returnable. In FIG. 4, a content handler component 414, presentation controller component 418, and a UI element handler component 416 may include and/or may be included in a user agent requesting a command. In an aspect, the user agent may be web application agent 406. In another aspect, an adaptation of the arrangement of components in FIG. 3a may operate in HTTP layer component 410. Browser 404 and/or web application agent 406 may provide the command information identified in recvCmd message 802 as user agent(s) to HTTP layer 410.

In yet another aspect, execution environment 402, including and/or provided by user agent node 602, may provide the command information in recvCmd message 802 in a network message to a relay node, such as proxy server, in network 606. The relay node is in a network path between a user agent in user agent node 602 and a server in server node 604. An adaptation of the arrangement of components in FIG. 3a may operate in an execution environment including and/or otherwise provided by the relay node. In the aspect, user agent node 602 may play the role of user agent according to the method illustrated in FIG. 2a.

A command may be determined to be non-returnable in a variety of computing contexts via any suitable mechanism, according to various aspects. A command may be determined to be non-returnable based on a user input detected by an input device, execution of an instruction received in an HTTP message, processing of a markup-element received in an HTTP message, accessing a location in a data storage medium, and receiving a configuration message.

For example, a bookmark menu bar 706b presented by a UI element handler component 416 in FIG. 4 may include a bookmark item identifying a URL. The URL may include metadata and/or may otherwise be associated with metadata indicating a command based on the URL is non-returnable when sent to a server node identified in the URL, in response to a user input for selecting the bookmark item. A user of browser 404 may configure the bookmark with the metadata. The user sending a command to the server based on the bookmark might not require a command response and/or might not have time to wait for a command response.

In another example, web application agent 406 may include a script instruction for sending a command to web application 504. The command may be sent to provide information to web application concerning web application agent's 406 state. Web application 504 may receive many such messages based on repeated execution of the script including the instruction. A missed message may be insignificant in the operation of web application agent 406 and web application 504, so a command response may be unnecessary or even inefficient to process. The script may be configured to identify and/or otherwise allow browser 404 to determine the command is non-returnable.

Alternatively or additionally, a command may be identified in a resource including a markup element specified for determining whether a command is non-returnable. For example, the markup element may be an anchor element or form element in an HTML document. The element may identify at least some command information. A markup element may be defined in a markup language for determining whether one or more commands associated with the markup element is/are non-returnable. Browser 404 may process the markup element in response to a user input corresponding to the anchor element or form element to determine that a command is non-returnable.

In another aspect, browser 404 may determine that a command is non-returnable based on data stored in a configuration file and/or database stored in a data storage media in execution environment 402. The determination may be based on a matching criterion for identifying non-returnable commands to be sent in HTTP requests.

The markup element, script instruction, and/or browser configuration may also be received by user agent node 602 and browser 404 via a message received from a node in network 606. Thus, determining whether a command is non-returnable may be performed in response to and/or otherwise based on receiving a message via a network. Access to web application agent 406 via one or more messages to web application 504 in server node 604 is described above.

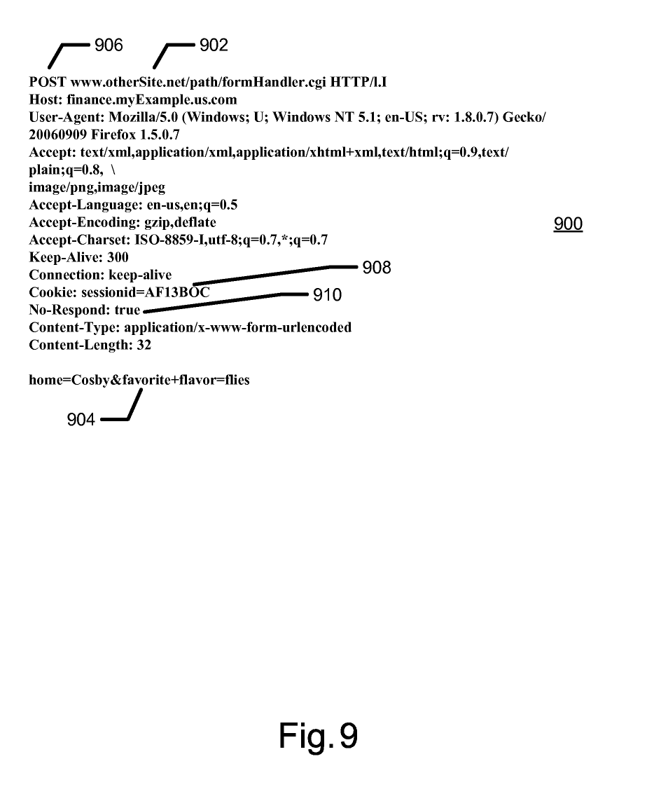

In another aspect, determining that a command is non-returnable may be based on no-return-request information stored in an HTTP request for sending command information to a server node. In FIG. 4, an HTTP request or a partial HTTP request may be provided to HTTP layer 410 including an adaptation of the arrangement of components in FIG. 3a and/or content manager component 412 may provide some or all of an HTTP request including no-return-request information to request-out component 456. FIG. 9 illustrates HTTP request 900 including no-respond HTTP header 910 included in no-return-request information. No-return-request information may be included and/or otherwise may be based on an HTTP method token, a URI, an HTTP message line, an HTTP general header, an HTTP message header, an HTTP entity, and an HTTP representation. HTTP request 900 is discussed in further detail below.

Determining that a command is non-returnable may be based on a state and/or other attribute of a user agent and/or server. Determining that a command is non-returnable may be based on a particular command type, a user of browser 404, a web application, a type of web application, a network address of a server node, a location of a server node, a security attribute associated with a user, and the like.

Command information for identifying a command in an HTTP request may be included in determining whether the command is non-returnable. For example, a URI scheme, scheme modifier, and/or attribute a URI may indicate that a command is returnable or non-returnable.

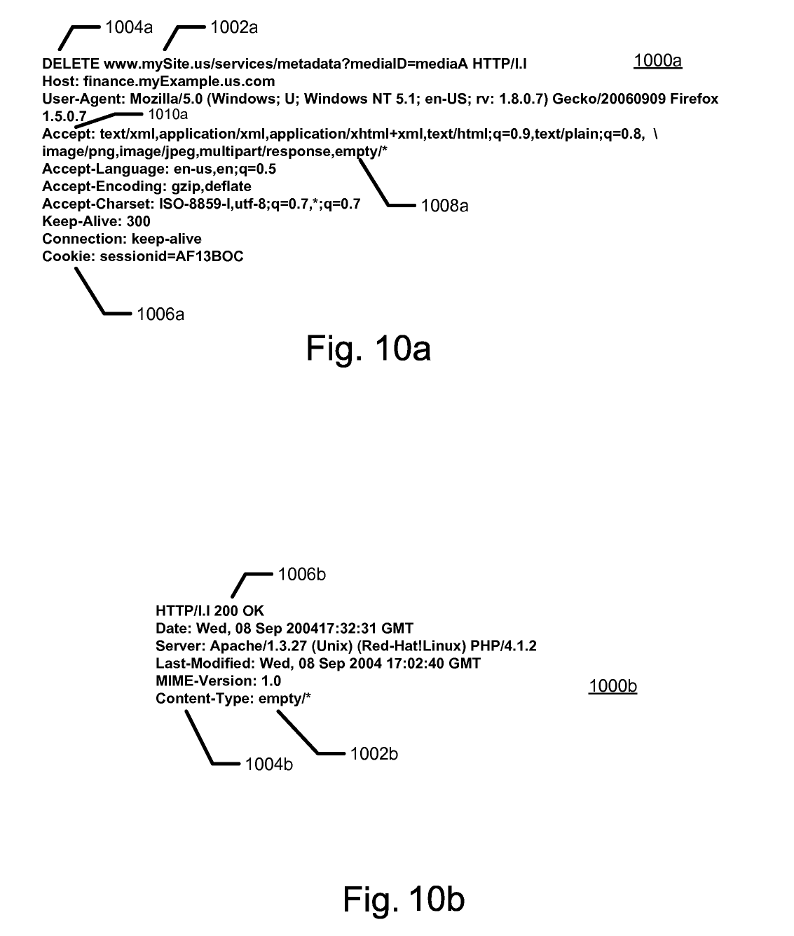

A command may be identified and/.or otherwise determined to be non-returnable by a MIME type identifier defined for indicating a command is non-returnable. HTTP request 1000a in FIG. 10a illustrates empty/* MIME type identifier 1008a defined to indicate an HTTP response with no command response is an acceptable HTTP response for a user agent node sending HTTP request 1000a.

Alternatively or additionally, a command may be determined to be non-returnable by and/or based on an HTTP method token defined to indicate that a command included in an HTTP request with the token is non-returnable. For example, a new HTTP method token, “POST-NORET” may be defined indicating that a command is non-returnable.

One or more of the MIME type identifier and the HTTP method token may further indicate to a server node that no command response is to be generated by the server node for a non-returnable command. One or more of the MIME type identifier and the HTTP method token may further indicate to a server node that no HTTP response is to be sent for an HTTP request identifying a non-returnable command.

Determining that a command is non-returnable may include evaluating a condition. No-response detector component 452 may detect whether a condition is met. When the condition is met, no-response detector component 452 may detect an indication that a command is non-returnable.

Returning to FIG. 2a, block 254 illustrates that the method additionally includes setting, in response to the determination, a no-return indicator in a data storage media. Accordingly, a system for preventing processing of an HTTP response includes means for setting, in response to the determination, a no-return indicator in a data storage media. For example, as illustrated in FIG. 3a, no-response policy component 354 is configured for setting, in response to the determination, a no-return indicator in a data storage media. FIG. 4 illustrates no-response policy component 454 as an adaptation of and/or analog of no-response policy component 354 in FIG. 3a.

FIG. 8 illustrates set message 806 communicated within user agent node 602 to set a no-return indicator in a data storage media to prevent sending, to the user agent, a command response from server node 604 for the command identified in recvCmd message 802.

No-response policy 454 in FIG. 4 may be invoked by no-response detector component 452, response-out 456, and/or another component in content manager component 412 to configure browser 404, HTTP layer 410, network stack 408, server node 604, and/or a node in a network path between server node 604 and user agent node 602 to prevent a command response from web application 504 from being sent to a user agent requesting a command.

In an aspect, setting a no-return indicator may include removing from, a return location in a data store, return information for sending, to the user agent, a command response to a command. In another aspect, setting a no-return indicator may include storing the no-return indicator in a no-return location in an accessible data storage media, such as a processor memory and/or a hard-drive. Alternatively or additionally, setting a no-return indicator may include storing no-return-request information in configuration message to send to a server node.

A no-return indicator stored in a no-return location and/or as no-return-request information sent in a configuration message is an indicator to one or more components included processing the command and/or command response that the command is non-returnable. The one or more components may be included in user agent node 602, server node 604, and/or in a node in a network path between user agent node 602 and server node 604. In FIG. 4, no-response policy component 454 may interoperate with request-out component 456 to store a no-return indicator in a no-return location, such a program variable in a processor memory in execution environment 402 and/or to store no-return-request information in first HTTP request message 808.

Returning to FIG. 2a, block 256 illustrates that the method additionally includes sending the first command information in the first HTTP request to the server, wherein the no-return indicator configures a node in a network path including the user agent and the server for sending no command response for the first command for delivery from the server to the user agent. Accordingly, a system for preventing processing of an HTTP response includes means for sending the first command information in the first HTTP request to the server, wherein the no-return indicator configures a node in a network path including the user agent and the server for sending no command response for the first command for delivery from the server to the user agent. For example, as illustrated in FIG. 3a, request-out component 356 is configured for sending the first command information in the first HTTP request to the server, wherein the no-return indicator configures a node in a network path including the user agent and the server for sending no command response for the first command for delivery from the server to the user agent. FIG. 4 illustrates request-out component 456 as an adaptation of and/or analog of request-out component 456 in FIG. 3a.

FIG. 8 illustrates first HTTP message 808 sent by user agent node 602 to server node 604 to process the command identified by recvCmd message 802. As described above, an HTTP request such as HTTP request 900 or HTTP request 1000a may be sent to web application 504 in server node 604 by request-out component 456 in user agent node 602. In FIG. 4, request-out component 456 operates in browser 404. Alternatively or additionally, another adaptation of request-out component 356 in FIG. 3a may operate in HTTP layer 410 along with other adaptations and/or analogs of other components illustrated in FIG. 3a.

Command information as well as additional data, if any, may be provided to content manager component 412 to generate an HTTP request including the command information, to identify a command for performing by a server. Command information may further include an HTTP method token, such as GET, POST, PUT, DELETE, and HEAD. An HTTP method token may be provided by browser 404, web application agent 406, and/or HTTP layer 410. Content manager component 412 in FIG. 4, operating in user agent node 602, may interoperate with HTTP layer 410 to send the first command information in first HTTP request message 808 to server node 604 via network 606. Server node 604 may be identified and located in network 606 by the first URI As described above HTTP layer 410 may send first HTTP request message 808 to server node 604 via network stack 408 and network 606.

HTTP request 900 may be sent by request-out component 456 in FIG. 4 in first HTTP request message 808 from user agent node 602 to server node 604. FIG. 9 illustrates HTTP request 900 including first command information identifying a first command. The first command information in HTTP request 900 includes first URI 902 illustrated as www.otherSite.net/path/formHandler.cgi identifying a command for processing form data 904 by web application 504. Form data 904 is illustrated as an HTTP representation encoded according to MIME type identifier “application/x-www-form-urlencoded”. A user agent may have no need for a response, may operate in a changing environment where a response will arrive too late to matter, and/or may be providing information to a server. First command information in HTTP request 900 may also include an HTTP method token 906 illustrated as “POST”. Additional data included in the first command information may be included in an HTTP header. For example, cookie header 908 identifies a session identifier illustrated by a “sessionid” cookie. A server may identify a command or an aspect of a command based on a value of a cookie and/or other HTTP header information. Server node 604 may be identified by a host portion of first URI 902, “www.otherSite.net”. HTTP request 900 illustrates first command information identifying the first command may include information in one or more of first URI 902, form data 904, HTTP method token 906, and cookie header 908.

FIG. 10a and FIG. 10b illustrate messages in an exemplary request/response exchange in an HTTP communication between browser 404 operating in user agent node 602 and web application 504 operating in server node 604. FIG. 10a illustrates HTTP request 1000a. HTTP request 1000a includes first URI 1002a illustrated as www.mySite.us/services/metadata?medialD=mediaA identifying a metadata service for maintaining metadata for various media entities, such as videos, audio recordings, and/or digital images. HTTP request 1000a also includes HTTP method token 1004a illustrated as “DELETE”. First URI 1002a includes a query portion identifying a keyword value pair as “medialD=mediaA”. In FIG. 10a, the query portion is included in the command information. Server node 604 may be identified by a host portion of first URI 1002a, www.otherSite.net. The identified command requests a metadata service in a server identified in first URI to delete metadata for media entity identified in the query portion of the URI. Cookie header 1006a may identify a user and/or role included in the command information. A session identifier” may identify a user account and may be part of the media identifier also including the query parameter “mediaA”. Command information identifying the first command in HTTP request 1000a may include information in one or more of first URI 1002a, HTTP method token 1004a, and cookie header 10006a.

No-return-request information may be included in an HTTP request to be sent in first HTTP request message 808 in FIG. 8. HTTP request 900 in FIG. 9 may be sent in first HTTP message 808. FIG. 9 illustrates the value “true” stored in a location in No. Respond header 908. No-respond header 908 may be included in no-return-request information. No-respond header 908 may be defined so that, in an aspect, the value “true” may be sent in HTTP request 900 in first HTTP request message 808 to prevent a command response for the command identified by HTTP request 900 from being delivered to a user agent sending the command, such as web application agent 406 and/or some or all of browser 404

In another aspect, no-return-request information and/or a no-return location may include and/or otherwise identify a MIME type specifying a content type including no command response for a user agent when included in an HTTP response and specifying that a command is non-returnable when included in an HTTP request. The MIME type identifier may be included in an HTTP request header, an HTTP general header, and/or an HTTP entity header. The MIME type identifier may be associated with an HTTP representation including no command response for a user agent. An HTTP entity and/or an HTTP representation may be empty based on the MIME type identifier.

FIG. 10a illustrates empty/* MIME type identifier 1008a stored in a location in Accept header 1010a in HTTP request 1000a. empty/* MIME type identifier 1008a may be sent in HTTP request 1000a in first HTTP request message 808 to identify the command in the request message as non-returnable.

Alternatively or additionally, no-return-request information and/or a no-return location may include and/or otherwise identify an HTTP method token defined to indicate that no HTTP response including a command response to the first command is to be sent by the server. The HTTP method token may further indicate that no command response is to be generated by the server node. Still further, the HTTP method token may be defined to indicate that HTTP request identifies a non-returnable command for which no corresponding HTTP response is to be transmitted.

With reference to FIG. 2b, block 260 illustrates that the method includes receiving, from a user agent via a first HTTP request, first command information identifying a first command. Accordingly, a system for preventing processing of an HTTP response includes means for receiving, from a user agent via a first HTTP request, first command information identifying a first command. For example, as illustrated in FIG. 3a, the request-in component 360 is configured for receiving, from a user agent via a first HTTP request, first command information identifying a first command. FIG. 5 illustrates request-in component 560 as an adaptation of and/or analog of request agent component 360 in FIG. 3b. One or more request-in components 560 operate in execution environment 502.

Request-in component 560 in FIG. 5, may receive an HTTP request such as first HTTP request message 808 from user agent node 602 via network stack 508, HTTP layer 510, and network application platform 506 as described above. Request-in component 560 may receive some or all information in an HTTP request by interoperating with network application platform 506. Request-in component 560 may identify a command received in an HTTP request, such the first command in first HTTP request message 808. Request-in component 560 may interoperate with one or more components in controller 512 to identify a command handler component 516 to perform an operation included in processing the command.

The command information may be based on an instruction sent to the user agent node in an HTTP message and/or a markup-element sent to the user agent node an HTTP message. For example, first HTTP request message 808 may be received in response to a resource sent by web application 504 in server node 604 to browser 404 in user agent node 602. As described above web application agent 406 may include an instruction in a script, byte code, and/or machine code for initiating an HTTP request from web application agent 406. Web application agent 406 may include a markup element defined for receiving first HTTP request message 808 from web application agent 406.

A web browser, a web server, a web application, a web application platform, and a proxy server may operate as user agents and/or servers. As described above and illustrated in FIG. 9 and FIG. 10a at least a portion of a command, such as the first command and/or the second command, identified in an HTTP request may be identified by command information including and/or included in an HTTP method token, a URI, an HTTP request line, an HTTP general header, an HTTP request header, and/or an HTTP entity that may be and/or may include an HTTP representation.

Returning to FIG. 2a, block 262 illustrates that the method further includes detecting no-return-request information identifying the first command as non-returnable for sending no command response for the first command from a server for delivery to the user agent. Accordingly, a system for preventing processing of an HTTP response includes means for detecting no-return-request information identifying the first command as non-returnable for sending no command response for the first command from a server for delivery to the user agent. For example, as illustrated in FIG. 3b, the response detector component 362 is configured for detecting no-return-request information identifying the first command as non-returnable for sending no command response for the first command from a server for delivery to the user agent. FIG. 5 illustrates response detector component 562 as an adaptation of and/or analog of response detector component 362 in FIG. 3b. One or more response detector components 562 operate in execution environment 502.

FIG. 8 illustrates detect message 810 communicated in server node 604 to an adaptation and/or analog of response detector component 362 to detect no-return-request information to identify the command in first HTTP request message 808 as non-returnable.

Response detector component 562 in FIG. 5 may be invoked to determine whether a command response should be sent for a command identified in an HTTP request before invoking a command handler component 516, during processing of an operation included in performing the command by a command handler component 516, and/or after processing of the command by a command handler component 516. Response detector component 562 may be invoked for detecting no-return-request information indicating no response to the command is to be sent to the sending user agent. No-return-request information may be detected and/or otherwise received in a variety of ways in various aspects described below.

An HTTP request may be sent by a user agent node and received by a server node without any explicit indication in the HTTP request that a command is non-returnable. In FIG. 4, browser 404 may instruct request-out 450 to send first HTTP request message 808 without determining whether the command identified in the HTTP request identifies a non-returnable command. Determining whether the command identified in first HTTP request message 808 is a non-returnable command may be left to web application 504.

Receiving no-return-request information, in an aspect of the method n in FIG. 2b, may include receiving no-return-request information based on a user input detected by an input device, a message sent to the user agent, accessing at least a portion of the no-return-request information from a location in a data storage media, and/or receiving a configuration message via a network including at least a portion of the no-return-request information. The no-return-request information may be received in response to and/or otherwise based on a markup-element, sent to the user agent node, defined to identify the no-return-request information and/or an instruction for executing by the user agent node for sending at least a portion of the no-return-request information. The no-return-request information may be based on at least one of an attribute of at least one of a user agent and a server included in sending and receiving an HTTP request.

In another aspect, no-return-request information may be detected in configuration information for web application agent 406 in FIG. 4. A script included in web application agent 406 may be configured to include and/or generate no-return-request information to include in an HTTP request sent by and/or in response to executing the script. Alternatively or additionally, a user of browser 404 may configure browser 404 to include no-return-request information in some or all HTTP requests according to the user's preferences and browser 404 capabilities. In still another aspect, no-return-request information may be received by browser 404 in a message sent by a systems management application operating in a remote node.

A message, such first HTTP request message 808, may be received by web application 504. No-return-request information included in the message may be received by response detector component 562 via request-in component 560, controller 512, a command handler component 516, a response generator 520, and/or other component included in processing the message. Some or all of the no-return-request information may be included in and/or otherwise identified by a no-respond header defined to indicate that a command identified in an HTTP request is a non-returnable command.

No-return-request information may be associated with a particular HTTP communication identified, for example, by a session identifier. No-return-request information may be HTTP request specific, command specific, application specific, user specific, device specific, and/or group specific, to name a few examples. No-return-request information may be sent by user agent node 602 to server node 604 via a protocol other than HTTP. For example, a systems management protocol may be used to exchange configuration options between user agent node 602 and server node 604.

Some or all no-return-request information for the non-returnable command identified in first HTTP request message 808 may be included and/or otherwise identified in first HTTP request message 808. Some or all of the no-return-request information may be identified based on command information in first HTTP request message 808. Alternatively or additionally, some of all of the no-return-request information may be included in another message received prior to sending any of a command response for the command in an HTTP response to user agent node 602.

In an aspect, no-return-request information may include a MIME-type identifier defined to identify a command as a non-returnable command. A server node may determine that a command identified in an HTTP request is a non-returnable command based on the MIME-type identifier. HTTP request 1000a in FIG. 10a includes an “empty/*” MIME type identifier. “Empty” and its various MIME subtypes may be defined to indicate that a command response to the command identified in HTTP request 1000a sent by a user agent is non-returnable. In FIG. 4, a text/html content handler component 414 may instruct content manager component to send first HTTP request message 808 in FIG. 8 including “empty/*” MIME type identifier 1008a in an HTTP ACCEPT header 1010a as illustrated in FIG. 10a to identify the command identified in HTTP request 1000a as a non-returnable command. In FIG. 5, response detector component 562 interoperating with controller 512 may detect MIME type identifier 1008a identifying the first command in HTTP request 1000a as non-returnable. Server node 604 may send an HTTP response including “empty/*” MIME type identifier defining the content type of the HTTP response as not including a command response.

Alternatively or additionally, no-return-request information may include and/or otherwise identify an HTTP method token defined to identify a command as non-returnable. The HTTP method token, “POST-NORET” defined in this manner is described above.

No-return-request information, such as a MIME type identifier and/or an HTTP method token identified in no-request-information, may further indicate to a server node that no command response is to be generated by the server. No-return-request information, such as a MIME type identifier and/or an HTTP method token identified in no-request-information, may indicate to a server node that no HTTP response is to be sent for an HTTP request.

No-return-request information may identify a no-return-request condition for evaluating by a server node and/or may be included in evaluating a no-return-request condition. In an aspect, a no-return-request condition may identify a temporal condition for evaluating by a server node. For example, no-return-request information processed by response detector component 562 in FIG. 5 may identify a condition based on a duration of time for processing and responding to a command received in an HTTP request. The condition is met when the command cannot be processed and/or responded to within the specified duration. The command may be determined to be a non-returnable command by the server node in response to determining that the no-return-request temporal condition is met. A command handler component 516 for a command may determine that the command received in an HTTP request cannot and/or has not been processed in the specified duration. In response, the command handler component 516 may interoperate with response detector component 562 to determine the command is a non-returnable command.

Returning to FIG. 2b, block 264 illustrates that the method yet further includes processing the first command including, in response to detecting the no-return-request information, sending no command response for the first command for delivery from the server to the user agent. Accordingly, a system for preventing processing of an HTTP response includes means for processing the first command including, in response to detecting the no-return-request information, sending no command response for the first command for delivery from the server to the user agent. For example, as illustrated in FIG. 3b, response director component 364 is configured for processing the first command including, in response to detecting the no-return-request information, sending no command response for the first command for delivery from the server to the user agent. FIG. 5 illustrates response director component 564 as an adaptation of and/or analog of response director component 364 in FIG. 3b. One or more response director components 564 operate in execution environment 502.

FIG. 8 illustrates process message 812 communicated in server node 604 to an adaptation and/or analog of response director component 364 receiving no-return-request information to process the indication that no command response to the command identified in first HTTP request message 808 is to be sent to the user agent node.

A command handler component 516 may be invoked in response to the command information included in first HTTP request message 808. Controller 512 and/or request-in component 560 may identify the command handler component 516 based on some or all of a URI in the first HTTP request message. Command information identifying the command may be processed by controller 512 in identifying a suitable command handler component 516.

A first command handler component 516 may be invoked by controller 512 for performing some or all of the processing for the first command identified by the first command information in first HTTP request message 808. Processing of a command, such as the first command, may generate and/or otherwise identify a result or command response. For first HTTP request message 808, a first command response and/or data for the first command response may be generated by first command handler component 516. A command response or a portion of a command response may include and/or provide access to any valid HTTP entity and/or HTTP representation such as hypertext markup language (HTML) and/or markup language, a scripting language, byte code, image data, audio data, and machine code.

In FIG. 5, response detector component 562 may invoke response director component 564 for sending no command response to a user agent for a non-returnable command. In an aspect, a server node might not send an HTTP response to an HTTP request identifying a non-returnable command sent from the user agent. Thus, a user agent might not receive an HTTP response to an HTTP request identifying a non-returnable command.

For example, an HTTP request may be exchanged between a user agent node and server node via a connection in connection-oriented protocol, such as a Transmission Control Protocol (TCP) connection according to the TCP protocol. Response director component 564 may determine whether a TCP connection in which the HTTP request was received is active. If the TCP connection is not active, no command response can be sent to the user agent node 602 via the connection. If the connection is active, response director component 564 may interoperate with controller component 512, request-out component 530, HTTP layer 510, and/or network stack 508 to deactivate the TCP connection after receiving the HTTP request. Response director component 564 may determine whether the connection is active before attempting to deactivate the connection or in some aspects may not check the status of the connection before attempting to deactivate the connection.

In FIG. 4, no-response-policy component 454 may similarly interoperate with request-out component 456, HTTP layer 410, and network stack 408 to deactivate the connection preventing a command response for the non-returnable command from being received. The connection, for example, may be closed or aborted. The no-return location may be modified to deactivate a connection after sending an HTTP request via the connection, in one aspect. In another aspect, a connection may be deactivated based on a value in the no-return location stored in setting a no-return indicator.

User agent node 602 may provide information in no-return-request information to indicate to server node 604 to deactivate the connection, to inform server node 604 that user agent node 602 will deactivate the connection, and/or to negotiate which node will deactivate the connection. In an aspect, both nodes may attempt to deactivate the connection. Adaptations of some or all the components in FIG. 3a operating external to browser 404, such as in HTTP layer 410 may operate analogously. Adaptations of some or all the components in FIG. 3a and/or in FIG. 3b operating in a node in a network path between user agent node 602 and server node 604 may also be configured to deactivate the connection as described or in any other suitable manner.

In addition to or instead of deactivating a connection either or both a user agent node and a server node that have exchanged an HTTP request, may release a resource required for sending a command response to a user agent that sent the non-returnable command. For example, either or both the user agent node and the server node may free a processor memory buffer for storing a command response.

In other aspects, a connection for exchanging an HTTP request may be left open for subsequent communication between a user agent node and a server node. User agent node 602 may send a second HTTP request identifying a second command to server node 604 after sending first HTTP request message 808. Server node 604 may send an HTTP response to the second HTTP request, in response to receiving the second HTTP request. User agent node 602 may receive the HTTP response. The second HTTP request and its HTTP response may be exchanged via the same connection by which first HTTP request message 808 was transmitted or may be exchanged via different connection. The HTTP response to the second HTTP request includes no portion of a command response for the command in first HTTP request 808 for delivering to a user agent that requested the command.

In other aspects, a server node may send and a user agent node may receive an HTTP response to first HTTP request 808, an attached HTTP response as described in application Ser. No. ______, (Docket No 0103) filed on May 27, 2010, entitled “Methods, Systems, and Program Products for Processing an Attached Command Response”, and/or a combined HTTP response described in application Ser. No. ______, (Docket No 0150) filed on May 27, 2010, entitled “Methods, Systems, and Program Products for Processing a Combined Command Response”. FIG. 8 illustrates first HTTP response message 814 as an HTTP response sent in processing the non-returnable command in first HTTP request 808 by some server nodes.

A server node may include no-return response information in first HTTP response message 814 to instruct a component in a receiving execution environment to prevent and/or otherwise not send a command response for a non-returnable command to a user agent that sent the non-returnable command to the server. Server node 604 may include no-return response information in first HTTP response message 814. No-response policy component 454 may be invoked in response to user agent node 602 receiving first HTTP response message 814 to block and/or otherwise not send a command response for the non-returnable command identified in first HTTP request message 808 to a sending user agent according to the no-return response information.

In FIG. 5, response director component 564 operating in server node 604 may communicate with response generator component 520 to instruct response-out component 530 to send first HTTP response message 814 as a response to first HTTP request message 808, as an attached HTTP response, or as a combined HTTP response. FIG. 10b illustrates an exemplary HTTP response 1000b to HTTP request 1000a. FIG. 10b illustrates that no-return response information may include a MIME type identifier in content-type header 1004b to specify a content type including no command response for a non-returnable command. “empty/*” MIME type identifier 1002b described above may be included in HTTP response 1000b, in an attached HTTP response, and/or in a combined HTTP response to indicate to user agent node 602 that no command response for a user agent is included in HTTP response 1000b, in the attached HTTP response, and/or in the combined HTTP response.

In some aspects, when server node 604 sends first HTTP response message 814, preventResp message 816 is communicated in user agent node 602. PreventResp message 816 is communicated to prevent any command response to the command identified in first HTTP request message 808 from being sent to a user agent that requested that the command be sent. No-response policy component 454 in FIG. 4 may detect the no-return response information and process the response including not sending a command response to a user agent that request the corresponding non-returnable command. FIG. 10b illustrates a status code 1006b. In an aspect, a status code indicating an error condition may be returned to a user agent.

A server node may send an HTTP message, which may include a command response for a non-returnable command to an execution environment including a sending user agent. No-response policy component 454 may process received HTTP response message 814 and a command response when included based on a no-return indicator stored in a no-return location in a data storage media in execution environment 402. No-response policy component 454 may access the no-return indicator and prevent and/or otherwise not send the command response to the user agent. Accessing the no-return indicator may include accessing a no-return location in a data storage media, such as a processor memory, and not locating return information, for identifying the command response as a response to the non-returnable command and/or for attempting and failing to identify a user agent to send the command response too. For example, information for correlating a non-returnable command and its command response may be removed or otherwise not stored in the no-return location (and/or return location).

Preventing a command response for a non-returnable command from being sent to a user agent may be left to a relay node in a network path between server node 604 and user agent node 602 and/or may be left to user agent node 602. This allows the subject matter described herein to be compatible with current web applications supporting current HTTP specifications. Sending an HTTP response including no command response and/or including no-return response information supports current request/response requirements of HTTP.

First HTTP response message 814 may be sent from server node 604 to user agent 602 before, during, and/or after processing the non-returnable command identified in first HTTP request message 808. Sending before and/or during processing allows user agent node 602 to process HTTP response message 814 for HTTP request 808 before and/or during processing of the non-returnable command.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for preventing processing of an HTTP response, the method comprising:
receiving, from a user agent, first command information identifying a first command for sending in a first HTTP request to a server;
determining that the first command is non-returnable indicating that no command response for the first command is to be sent for delivery from the server to the user agent;
setting, in response to the determination, a no-return indicator in a data storage media; and.
sending the first command information in the first HTTP request to the server, wherein the no-return indicator configures a node in a network path including the user agent and the server for sending no command response for the first command for delivery from the server to the user agent.

2. The method of claim 1 wherein setting the no-return indicator includes storing in the data storage media at least one of storing no-return-request information, indicating that the first command is non-returnable, in a location in a configuration message to send to a server node including the server and storing the no-return indicator in a no-return location for accessing in response to receiving a response message from the server node.

3. The method of claim 2 wherein at least one of the no-return location and the no-return-request information identifies at least one of a MIME type identifier and an HTTP method token for at least one of specifying a content type that identifies no command response for sending to the user agent and for identifying to the server node the first command as non-returnable.

4. The method of claim 2 wherein the no-return-request information is defined to indicate at least one of that no command response is to be generated by the server and that the no HTTP response corresponding to the first HTTP request is to be sent by the server node.

5. The method of claim 2 further includes sending the configuration message to the server node.

6. The method of claim 5 wherein the configuration message is included in the first HTTP request.

7. The method of claim 2 further includes receiving at least one of a first HTTP response to the first HTTP request, a combined HTTP response, and an attached HTTP response.

8. The method of claim 7 further includes receiving a first command response to the first command in at least one of the first HTTP response to the first HTTP request, the combined HTTP response, and the attached HTTP response.

9. The method of claim 8 further comprising:
accessing the no-return location; and
in response to accessing the no-return location, not sending the first command response to the user agent.

10. The method of claim 8 wherein at least one of the first HTTP response to the first HTTP request, the combined HTTP response, and the attached HTTP response includes no-return-response information, based on the no-return-request information.

11. The method of claim 10 wherein the no-return-response information identifies a MIME type specifying a content-type that identifies no command response for sending to the user agent.

12. The method of claim 1 wherein sending the first HTTP request comprises:
sending the first HTTP request via a connection according to a connection-oriented protocol; and
deactivating, based on setting the no-return indicator, the connection subsequent to sending the first HTTP request to prevent receiving any command response to the first command via the connection.

13. A method for preventing processing of an HTTP response, the method comprising:
receiving, from a user agent via a first HTTP request, first command information identifying a first command;
detecting no-return-request information identifying the first command as non-returnable for sending no command response for the first command from a server for delivery to the user agent; and
processing the first command including, in response to detecting the no-return-request information, sending no command response for the first command for delivery from the server to the user agent.

14. The method of claim 13 wherein the no-return-request information is detected based on at least one of a user input detected by an input device, a message sent to the user agent, accessing at least a portion of the no-return-request information from a location in a data storage media, and receiving a configuration message via a network including at least a portion of the no-return-request information.

15. The method of claim 13 wherein the no-return-request information identifies, defined for identifying the first command as non-returnable, at least one of a MIME type identifier and an HTTP method token.

16. The method of claim 13 wherein the no-return-request information indicates at least one of that no command response is to be generated by the server and that the first HTTP request has no corresponding HTTP response.

17. The method of claim 13 wherein detecting the no-return request information includes receiving at least a portion of the no-return-request information in the first HTTP request.

18. The method of claim 13 wherein the first HTTP request is received via a connection according to a connection-oriented network protocol and sending no command response includes deactivating the connection subsequent to receiving the first HTTP request to prevent sending any command response to the first command via the connection.

19. The method of claim 13 wherein the sending no command response includes sending no-return-response information based on the no-return-request information in at least one of a first HTTP response to the first HTTP request, a combined HTTP response, and an attached HTTP response, wherein the no-return-response information is for preventing any command response to the first command from being delivered to the user agent.

20. A system for preventing processing of an HTTP response, the system comprising:
an execution environment including an instruction processing unit configured to process an instruction included in at least one of a request agent component, a no-response detector component, a no-response policy component, and a request-out component;
the request agent component configured for receiving, from a user agent, first command information identifying a first command for sending in a first HTTP request to a server;
the no-response detector component configured for determining that the first command is non-returnable indicating that no command response for the first command is to be sent for delivery from the server to the user agent;
the no-response policy component configured for setting, in response to the determination, a no-return indicator in a data storage media; and
the request-out component configured for sending the first command information in the first HTTP request to the server, wherein the no-return indicator configures a node in a network path including the user agent and the server for sending no command response for the first command for delivery from the server to the user agent.

21. A system for preventing processing of an HTTP response, the system comprising:
an execution environment including an instruction processing unit configured to process an instruction included in at least one of a request-in component, a response detector component, and a response director component;
the request-in component configured for receiving, from a user agent via a first HTTP request, first command information identifying a first command;
the response detector component configured for detecting no-return-request information identifying the first command as non-returnable for sending no command response for the first command from a server for delivery to the user agent; and
the response director component configured for processing the first command including, in response to detecting the no-return-request information, sending no command response for the first command for delivery from the server to the user agent processing the first command including, in response to detecting the no-return-request information, sending no command response for the first command for delivery from the server to the user agent

22. A computer readable medium embodying a computer program, executable by a machine, for preventing processing of an HTTP response, the computer program comprising executable instructions for:
receiving, from a user agent, first command information identifying a first command for sending in a first HTTP request to a server;
determining that the first command is non-returnable indicating that no command response for the first command is to be sent for delivery from the server to the user agent;
setting, in response to the determination, a no-return indicator in a data storage media; and
sending the first command information in the first HTTP request to the server, wherein the no-return indicator configures a node in a network path including the user agent and the server for sending no command response for the first command for delivery from the server to the user agent.

23. A computer readable medium embodying a computer program, executable by a machine, for preventing processing of an HTTP response, the computer program comprising executable instructions for:
receiving, from a user agent via a first HTTP request, first command information identifying a first command;
detecting no-return-request information identifying the first command as non-returnable for sending no command response for the first command from a server for delivery to the user agent; and
processing the first command including, in response to detecting the no-return-request information, sending no command response for the first command for delivery from the server to the user agent.
